(19) United States
(12) Patent Application Publication
(10) Pub. No.: US 2026/0181228 A1
(43) Pub. Date: Jun. 25, 2026

(54) CAMERA MODULE

(71) Applicant: Samsung Electro-Mechanics Co., Ltd., Suwon-si (KR)

(72) Inventors: Kangjin LEE, Suwon-si (KR); Kyungmin SEO, Suwon-si (KR)

(73) Assignee: Samsung Electro-Mechanics Co., Ltd., Suwon-si (KR)

(21) Appl. No.: 19/221,829

(22) Filed: May 29, 2025

(30) Foreign Application Priority Data
Dec. 20, 2024 (KR) 10-2024-0192682

(51) Int. Cl. H04N 23/51; G03B 30/00

(52) U.S. Cl. CPC H04N 23/51; G03B 30/00

(57) ABSTRACT

A camera module includes a lens barrel; a carrier configured to accommodate the lens barrel; a housing configured to accommodate the carrier; a substrate disposed on an outer surface of a side wall of the housing; an image sensor configured to convert incident light to an electric signal; a circuit board electrically connected to the image sensor; and a cover disposed to enclose the housing and the substrate. A fastening recess is disposed on the outer surface of the side wall of the housing, where the substrate is disposed, and the housing has a fastening cover portion configured to cover at least a portion of the fastening recess.

### CROSS-REFERENCE TO RELATED APPLICATION

This application claims the benefit under 35 USC 119(a) of Korean Patent Application No. 10-2024-0192682 filed on Dec. 20, 2024, in the Korean Intellectual Property Office, the entire disclosure of which is incorporated herein by reference for all purposes.

### BACKGROUND

### 1. Field

The present disclosure relates to a camera module.

### 2. Description of the Background

Camera modules are used in smartphones, notebooks, vehicles, etc. High-performance camera modules are used in videography and for vehicles to support advanced driver assistance systems (ADAS) for autonomous driving.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens barrel; a carrier configured to accommodate the lens barrel; a housing configured to accommodate the carrier; a substrate disposed on an outer surface of a side wall of the housing; an image sensor configured to convert incident light to an electric signal; a circuit board electrically connected to the image sensor; and a cover disposed to enclose the housing and the substrate. A fastening recess is disposed on the outer surface of the side wall of the housing, where the substrate is disposed, and the housing has a fastening cover portion configured to cover at least a portion of the fastening recess.

The fastening cover portion may be disposed at an upper portion of the outer surface of the side wall of the housing.

The housing may include a first side wall portion, a second side wall portion, a third side wall portion, and a fourth side wall portion. The first wall portion may face the third side wall portion, and the second wall portion may face the fourth side wall portion. The substrate may be disposed across the first side wall portion, the second side wall portion, and the third side wall portion.

The fastening cover portion may be disposed on the first side wall portion.

The fastening cover portion may be disposed adjacent to a corner where the first side wall portion and the second side wall portion meet each other.

The fastening cover portion may be disposed in an intermediate region between corners of the housing.

The fastening cover portion may be disposed to cover a length direction end portion of the substrate.

The fastening cover portion may be disposed in a middle region of the side wall of the housing in a vertical direction.

In another general aspect, a camera module includes a lens barrel; a carrier configured to accommodate the lens barrel; a housing configured to accommodate the carrier; a substrate disposed on an outer surface of a side wall of the housing; an image sensor configured to convert incident light to an electric signal; a circuit board electrically connected to the image sensor; and a cover disposed to enclose the housing and the substrate. The housing has a fastening cover portion configured to cover at least a portion of the substrate.

A fastening recess may be disposed on the outer surface of the side wall of the housing.

The fastening cover portion may be spaced apart from the fastening recess.

Other features and aspects will be apparent from the following detailed description, the drawings, and the claims.

### BRIEF DESCRIPTION OF THE DRAWINGS

FIG. 1 is a perspective view of a camera module according to an embodiment.

FIG. 2 is an exploded perspective view of the camera module.

FIG. 3 is an exploded perspective view of the housing 120 and the substrate 600 of FIG. 2.

FIG. 4 shows the substrate 600 fixed to the outer surface of housing 120.

FIG. 5 shows an A region of FIG. 4.

FIG. 6 shows a region B of FIG. 4.

FIG. 7 shows a housing 120a and a substrate 600a according to another embodiment.

FIG. 8 shows a housing 120b and a substrate 600b according to another embodiment.

FIG. 9 shows a housing 120c and a substrate 600c according to another embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

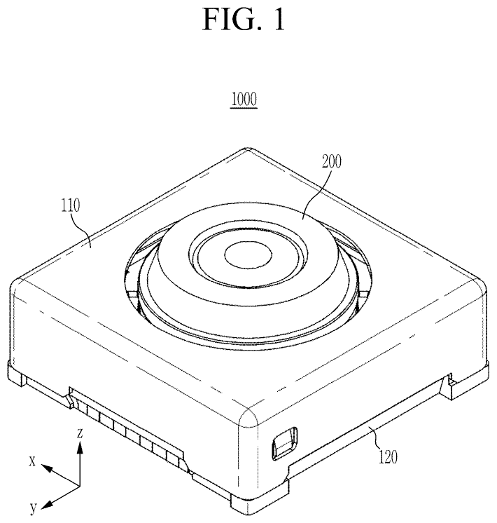

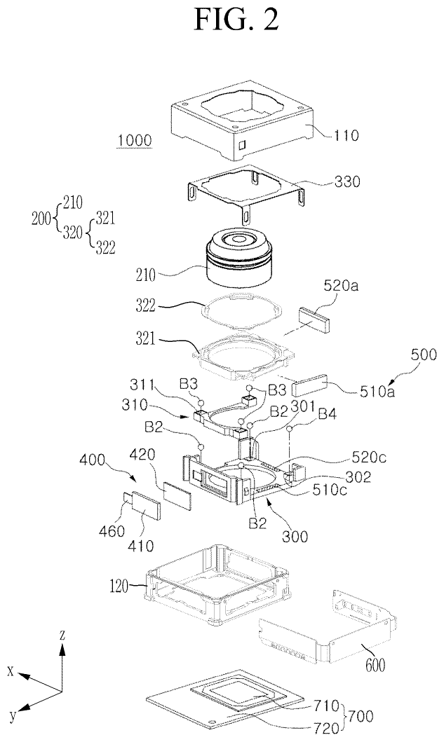

FIG. 1 is a perspective view of a camera module according to an embodiment, and FIG. 2 is an exploded perspective view of the camera module.

Referring to FIGS. 1 and 2, the camera module 1000 according to the embodiment may include a lens module 200, an image sensor module 700 converting light incident through the lens module 200 into an electric signal, a housing 120 accommodating the lens module 200 therein, a cover 110 coupled to the housing 120 and covering an outer surface of the housing 120, and a circuit board 720 coupled to a lower portion of the housing 120 and on which an image sensor 710 is mounted.

The lens module 200 may include a lens barrel 210 that accommodates a lens therein, and a lens holder 320 coupled with the lens barrel 210. The lens holder 320 may include a holder member 321 and a yoke member 322 disposed on the holder member 321.

The lens barrel 210 may have a hollow cylinder shape so that a plurality of lenses for photographing a subject may be accommodated therein. The plurality of lenses may be mounted on the lens barrel 210 along an optical axis (z-axis in the figures).

The plurality of lenses may be arranged in a desired number according to the design of the lens barrel 210, and each lens may have optical characteristics such as the same or different refractive index.

A lens driving apparatus may move the lens module 200. For example, the lens driving apparatus may adjust the focus by moving the lens module 200 in the optical axis (z-axis) direction. By moving the lens module 200 in a direction (x-axis direction and/or y-axis direction) perpendicular to the optical axis (z-axis), a camera shake during shooting may be corrected.

The lens driving apparatus may include an auto focus (AF) unit 400 for adjusting focus and an optical image stabilization (OIS) unit 500 for correcting the camera shake.

The image sensor module 700 may convert incident light that passes through the lens into an electric signal. For example, the image sensor module 700 may include an image sensor 710 and a circuit board 720 connected to the image sensor 710. The image sensor module 700 may further include an infrared filter. For example, the circuit board 720 may be a printed circuit board (PCB) and may be coupled to a lower portion of the housing 120. The infrared filter may block infrared light from passing through a lens.

The image sensor 710 may convert incident light that passes through the lens into an electric signal. For example, the image sensor 710 may be a CCD (Charge Coupled Device) or CMOS (Complementary Metal-Oxide Semiconductor). The electric signal converted by the image sensor 710 may be output as an image through the display unit of a portable electronic device. The image sensor 710 may be electrically connected to the circuit board 720. For example, the image sensor 710 is fixed to the circuit board 720 and may be electrically connected to the circuit board 720 by wire bonding.

The lens module 200 and the lens driving apparatus may be accommodated in the housing 120. The housing 120 may be a box structure in which upper and lower portions are open. As an example, the housing 120 may have a polyhedron shape with a rectangular cross-section and a predetermined height. The lens module 200, the lens driving apparatus, and a carrier 300 may be accommodated in an internal space of the housing 120. The carrier 300 may be accommodated in the housing 120 by being inserted from the top to the bottom of the housing 120. The image sensor module 700 may be disposed in the lower portion of the housing 120.

In addition, a substrate 600 that provides a driving signal to the AF unit 400 and the OIS unit 500 may be disposed on a side surface of the housing 120. For example, the substrate 600 may be a single substrate that wraps around the side surface of the housing 120. On the side surface of the housing 120, as described below, an opening may be provided so that an AF (Auto Focus) drive coil and a first position detector of the AF unit 400, and the first OIS drive coil of, a second OIS drive coil and the second position detector of the OIS unit 500 can be inserted.

The cover 110 is positioned to enclose the housing 120 and the substrate 600. The cover 110 may serve to protect the internal components of the camera module 1000. In addition, the cover 110 may serve to shield electromagnetic waves. For example, the cover 110 may shield electromagnetic waves so that the electromagnetic waves generated by the camera module 1000 do not affect other electronic components in a portable electronic device. Meanwhile, since the portable electronic device is equipped with various electronic components other than the camera module, the cover 110 may shield electromagnetic waves so that electromagnetic waves generated by the various electric components do not affect the camera module. The cover 110 is provided with a metallic material and may be grounded to a ground pad provided on the circuit board 720, thereby shielding electromagnetic waves.

The lens module 200 can be moved by the lens driving apparatus to focus on the subject. For example, the camera module 1000 according to the embodiment may have the AF unit 400 that moves a lens module 200 in the optical axis (z-axis) direction. The AF unit 400 may include the carrier 300 that accommodates the lens module 200, and an AF driver that is disposed on the outside of the carrier 300 and generates a driving torque to move the lens module 200 and the carrier 300 in the optical axis (z-axis) direction. The AF driver may include an AF driving magnet 410 and an AF driving coil.

The AF driving magnet 410 may be mounted on the carrier 300. For example, the AF driving magnet 410 may be mounted on one surface of the carrier 300.

The AF driving coil may be arranged to face the AF driving magnet 410. The AF driving coil may be a copper foil pattern laminated and embedded in substrate 600. The substrate 600 may be mounted on the side surface of the housing 120 so that the AF driving magnet 410 and the AF drive coil face each other in a direction perpendicular to the optical axis (z-axis).

The AF driving magnet 410 may be a moving member mounted on the carrier 300 and moving along the optical axis (z-axis) direction with the carrier 300, and the AF driving coil may be a fixed member attached to the housing 120. When power is applied to the AF driving coil, the carrier 300 may be moved in the optical axis (z-axis) direction by an electromagnetic force between the AF driving magnet 410 and the AF driving coil.

The carrier 300 may accommodate a frame 310, a holder member 321, and a yoke member 322. Since the lens barrel 210 is mounted on the lens holder 320, the frame 310, the lens holder 320, and the lens barrel 210 may also move in the optical axis (z-axis) direction by moving the carrier 300.

When the carrier 300 is moved, a first rolling member may be placed between the carrier 300 and the housing 120 to reduce friction between the carrier 300 and the housing 120. The first rolling member may have a ball shape. For example, the first rolling member may be disposed on both sides of the AF driving magnet 410, and the first rolling member may have a form in which multiple balls are connected.

The first yoke may be disposed so as to face the AF driving magnet 410 in a direction perpendicular to the optical axis (z-axis). For example, the first yoke may be mounted on the outer surface of substrate 600. That is, the first yoke may be mounted on the side opposite to the surface where the AF driving coil is embedded. Therefore, the first yoke may be disposed to face the AF driving magnet 410 with the AF drive coil interposed therebetween. First, a force may be applied between the yoke and the AF drive magnet 410 in a direction perpendicular to the optical axis (z-axis). Therefore, the first rolling member may maintain contact with the carrier 300 and housing 120 by the attractive force between the first yoke and the AF driving magnet 410.

In addition, the first yoke may also function to focus the magnetic force of the AF driving magnet 410. Accordingly, an occurrence of leakage flux may be prevented. For example, the first yoke and the AF driving magnet 410 may form a magnetic circuit.

A second yoke 420 may disposed between the AF driving magnet 410 and the carrier 300. The second yoke 420 may function to focus the magnetic force of the AF driving magnet 410. Therefore, an occurrence of leakage flux may be prevented. For example, the second yoke 420 and the AF driving magnet 410 may form a magnetic circuit.

The camera module 1000 according to the embodiment may use a closed-loop control method that detects and feeds back a position of the lens module 200. Therefore, a first position detector may be provided for the closed-loop control. The first position detector may include a plurality of coils and a controller electrically connected to the plurality of coils. The first position detector may include a plurality of coils arranged along the optical axis (z-axis) direction. For example, the first position detector may include two coils arranged along the optical axis (z-axis) direction. The plurality of coils may also be a copper foil pattern laminated and embedded in the substrate 600, similar to the AF drive coil.

The plurality of coils of the first position detector may be disposed to face a sensing yoke 460, which is disposed adjacent to the AF driving magnet 410. The sensing yoke 460 is mounted on one surface of the carrier 300, and the sensing yoke 460 may be a conductor or a magnetic body. The plurality of coils may be arranged to face the sensing yoke 460 in a direction perpendicular to the optical axis (z-axis). In addition, the plurality of coils may be disposed adjacent to the AF driving coil.

As the carrier 300 moves in the optical axis (z-axis) direction, the sensing yoke 460 mounted on the carrier 300 may move in the optical axis (z-axis) direction. Accordingly, an inductance of the plurality of coils may change. The controller may receive inductance values from the plurality of coils and detect the position of the lens barrel 210 (position in the optical axis (z-axis) direction). Therefore, the controller may detect the position of the sensing yoke 460 from the change in inductance of the plurality of coils. The sensing yoke 460 is mounted on the carrier 300, which may accommodate the lens barrel 210. Since the carrier 300 moves along the optical axis (z-axis) direction together with the lens barrel 210, the first position detector may ultimately detect the position of the lens barrel 210 (position in the optical axis (z-axis) direction) from the change in inductance of the plurality of coils.

When the sensing yoke 460 moves in the optical axis (z-axis) direction, the position of the lens barrel 210 in the optical axis (z-axis) direction may be detected more accurately by utilizing the signal difference generated from the two coils of the first position detector. The inductance values of the two coils may change not only due to the difference in their relative positions with respect to the sensing yoke 460, but also due to changes in the temperature of the surrounding environment.

However, in the present embodiment, the exact position of the lens barrel 210 may be detected by removing factors such as temperature changes in the surrounding environment. For example, depending on the movement of the sensing yoke 460, the inductance of the two coils may increase or decrease in different directions. That is, when the inductance of one coil increases, the inductance of the other coil may decrease. Therefore, when the inductance values of a plurality of coils are subtracted from each other, the factor caused by temperature change in the surrounding environment may be removed. Accordingly, the position of the lens barrel 210 in the optical axis (z-axis) direction may be precisely detected.

Meanwhile, in the present embodiment, it has been described that the plurality of coils of the first position detector faces the sensing yoke 460, but it may also be possible to arrange the plurality of coils to face the AF driving magnet 410 without the sensing yoke 460.

The OIS unit 500 may be used to correct image blur or motion picture shake caused by factors such as the user's shaking hands when taking an image or motion picture. For example, the OIS unit 500 may compensate for shakes when shaking occurs during image shooting due to the user's shaking hand, etc., by providing relative displacement corresponding to the shake to the lens barrel 210. As a specific example, the OIS unit 500 may correct shake by moving the lens barrel 210 in a direction perpendicular to the optical axis (z-axis).

The OIS unit 500 may include a guide member that guides the movement of the lens barrel 210, and an OIS driver that is disposed on the outside of the lens holder 320 and generates a driving torque to move the guide member in a direction perpendicular to the optical axis (z-axis). The OIS driver may include a plurality of OIS (Optical Image Stabilization) driving magnets and a plurality of OIS driving coils.

The plurality of OIS driving magnets may include a first OIS driving magnet 510a and a second OIS driving magnet 520a, and the plurality of OIS driving coils may include a first OIS driving coil and a second OIS driving coil.

The guide member may include a frame 310 and the lens holder 320. The frame 310 and lens holder 320 are sequentially inserted into the carrier 300 along the optical axis (z-axis) direction, and may have the function of guiding the movement of the lens barrel 210.

The frame 310 and lens holder 320 may have a space into which the lens barrel 210 may be inserted. The lens barrel 210 may be fixed with an insertion into the lens holder 320. The frame 310 may be disposed on one surface of the lens holder 320.

For example, the frame 310 of the guide member may have a shape in which two sides of a quadrangle are removed when viewed in the optical axis (z-axis) direction. The first OIS driving magnet 510a and the second OIS driving magnet 520a may be respectively disposed on the two removed sides of frame 310. Therefore, the arrangement positions of the first OIS driving magnet 510a and the second OIS driving magnet 520a may not be affected by the frame 310. Accordingly, the overall height of the camera module may not be increased. However, the shape of frame 310 is not limited to this, and various shapes such as a quadrangle plane shape may be used.

The frame 310 and the lens holder 320 may move in a direction perpendicular to the optical axis (z-axis) with respect to the carrier 300 due to the driving torque generated by the plurality of OIS driving magnets and the plurality of OIS driving coils. The first OIS driving magnet 510a and the first OIS driving coil may generate driving torque in a first axis (x-axis) direction perpendicular to the optical axis (z-axis), and the second OIS driving magnet 520a and the second OIS driving coil may generate driving torque in a second axis (y-axis) direction perpendicular to the first axis (x-axis). That is, the plurality of OIS driving magnets and the plurality of OIS driving coils may generate driving torque in directions facing each other. Here, the second axis (y-axis) may mean the axis that is perpendicular to both the optical axis (z-axis) and the first axis (x-axis).

The plurality of OIS driving magnets may be arranged to be orthogonal to each other in a plane perpendicular to the optical axis (z-axis), and the plurality of OIS driving coils may also be arranged to be orthogonal to each other in a plane perpendicular to the optical axis (z-axis).

The first OIS driving magnet 510a and the second OIS driving magnet 520a may be mounted on the holder member 321. For example, each of the first OIS driving magnet 510a and the second OIS driving magnet 520a may be mounted on a side surface of the holder member 321. The side surface of the holder member 321 includes a first surface and a second surface that are perpendicular to each other, and the first OIS driving magnet 510a and the second OIS driving magnet 520a may be disposed on the first surface and the second surface of the holder member 321.

The first OIS driving coil and the second OIS driving coil may be copper foil patterns laminated and embedded in the substrate 600. The substrate 600 can be mounted on the side surface of the housing 120 such that the first OIS drive magnet 510a and the first OIS drive coil face each other in the first axis (x-axis) direction perpendicular to the optical axis (z-axis), and the second OIS drive magnet 520a and the second OIS drive coil face each other in the second axis (y-axis) direction perpendicular to the optical axis (z-axis) and the first direction.

The first OIS driving magnet 510a and the second OIS driving magnet 520a are movable members that move in a direction perpendicular to the optical axis (z-axis) together with the lens holder 320, and the first OIS driving coil and the second OIS driving coil may be fixed members fixed to the housing 120.

In the present embodiment, a plurality of rolling members supporting the frame 310 and the lens holder 320 of the OIS unit 500 may be provided. The plurality of rolling members may function to guide the movement of the frame 310, lens holder 320, and lens barrel 210 during the shake correction process. In addition, the plurality of rolling members can also function to maintain a gap between the carrier 300, frame 310, and lens holder 320. A second rolling member B2 and the third rolling member B3 may have ball shape.

The plurality of rolling members may include the second rolling member B2 and the third rolling member B3. For example, the second rolling member B2 may guide the movement of the frame 310, the lens holder 320, and the lens barrel 210 in the first axis (x-axis) direction. In addition, the third rolling member B3 may guide the movement of the lens holder 320 and the lens barrel 210 in the second axis (y-axis) direction. As a specific example, the second rolling member B2 may roll in the first-axis (x-axis) direction when a driving torque is generated in the first-axis (x-axis) direction. Accordingly, the second rolling member B2 may guide the movement of the frame 310, the lens holder 320, and the lens barrel 210 in the first axis (x-axis) direction.

As another specific example, the third rolling member B3 may roll in the second-axis (y-axis) direction when a driving torque is generated in the second-axis (y-axis) direction. Accordingly, the third rolling member B3 may guide the movement of the lens holder 320 and the lens barrel 210 in the second axis (y-axis) direction.

The second rolling member B2 may include a plurality of rolling members disposed between the carrier 300 and the frame 310. The third rolling member B3 may include a plurality of rolling members disposed between the frame 310 and the lens holder 320.

On one surface of the carrier 300 where the carrier 300 and frame 310 face each other in the optical axis (z-axis) direction, a first guide recess portion 301 for accommodating the second rolling member B2 may be disposed. The first guide recess portion 301 may include a plurality of guide recess corresponding to the plurality of rolling members of the second rolling member B2. The second rolling member B2 may be accommodated in the first guide recess 301 and inserted between the carrier 300 and the frame 310.

The second rolling member B2, while accommodated in the first guide recess portion 301, is restricted from moving in the optical axis (z-axis) and the second axis (y-axis) directions, and may only move in the first axis (x-axis) direction. For example, the second rolling member B2 may only move in the first axis (x-axis) direction. To this end, the planar shape of a plurality of guide recess of the first guide recess portion 301 may be a rectangle having a length in the first axis (x-axis) direction.

On the surfaces where the frame 310 and the lens holder 320 face each other in the optical axis (z-axis) direction, a second guide recess portion 311 that accommodates the third rolling member B3 may be disposed. The second guide recess portion 311 may include a plurality of guide recess corresponding to a plurality of rolling members of the third rolling member B3.

The third rolling member B3 may be accommodated in the second guide recess 311 and inserted between the frame 310 and the lens holder 320.

The third rolling member B3, while accommodated in the second guide recess part 311, is restricted from moving in the optical axis (z-axis) and first-axis (x-axis) directions, and can only move in the second-axis (y-axis) direction. For example, the third rolling member B3 may only move in the second axis (y-axis) direction. To this end, the plane shape of a plurality of guide recess of the second guide recess portion 311 may be a rectangle having a length in the second axis (y-axis) direction.

In addition, the camera module 1000 according to the embodiment may include a fourth rolling member B4 disposed between the carrier 300 and the lens holder 320 to support movement of the lens holder 320. The fourth rolling member B4 may support a lens holder 320 that moves in the first axis (x-axis) direction and the second axis (y-axis) direction. For example, the fourth rolling member B4 may roll along the first axis (x-axis) when a driving torque is applied in the first-axis (x-axis) direction. In addition, the fourth rolling member B4 may roll along the second axis (y-axis) when a driving torque is applied in the second axis (y-axis) direction.

The third rolling member B3 and the fourth rolling member B4 may contact and support the lens holder 320. An accommodation recess 302 for accommodating a fourth rolling member B4 may be positioned on at least one of the surfaces where the carrier 300 and the lens holder 320 face each other in the optical axis (z-axis) direction. The fourth rolling member B4 may be accommodated in the accommodation recess 302 and inserted between the carrier 300 and the lens holder 320. The fourth rolling member B4, while accommodated in the accommodation recess 302, is restricted from moving in the optical axis (z-axis) direction and may move along the first axis (x-axis) and second axis (y-axis). To this end, the accommodation recess 302 may be formed into a circular plane shape. Therefore, the shape of the accommodation recess 302 and the shapes of the first guide recess portion 301 and the second guide recess portion 311 may be different from each other.

Meanwhile, the camera module 1000 according to the embodiment may include a plurality of yokes 510c and 520c to maintain contact between the OIS unit 500 and the second to fourth rolling members B2, B3, and B4. The plurality of yokes 510c and 520c may be fixed to the carrier 300 and disposed to face the first OIS driving magnet 510a and the second OIS driving magnet 520a in the optical axis (z-axis) direction. Therefore, an attractive force may be generated in the optical axis (z-axis) direction between the plurality of yokes 510c and 520c and the first OIS driving magnet 510a and the second OIS driving magnet 520a.

The OIS unit 500 may be pressed in a direction toward the plurality of yokes 510c and 520c by the attractive force between the plurality of yokes 510c and 520c and the first OIS driving magnet 510a and the second OIS driving magnet 520a. Therefore, the frame 310 and the lens holder 320 of the OIS unit 500 may maintain contact with the second to fourth rolling members B2, B3, and B4.

The plurality of yokes 510c and 520c may be a material capable of generating an attractive force with the first OIS driving magnet 510a and the second OIS driving magnet 520a. For example, the plurality of yokes 510c, and 520c may be magnetic body.

A camera module 1000 according to the embodiment may include a stopper 330 to prevent the second to fourth rolling members B2, B3, and B4, the frame 310, and the lens holder 320 from being separated from the carrier 300 due to external impact. The stopper 330 can be attached to the carrier 300 so as to cover at least a portion of the upper surface of the lens holder 320.

The camera module 1000 according to the embodiment may use a closed-loop control method that detects and feeds back the position of the lens barrel 210 during a shake correction process. Accordingly, the camera module 1000 may include a second position detector for the closed-loop control. The second position detector can be configured to detect the position of the lens barrel 210 in the first axis (x-axis) direction and the second axis (y-axis) direction. The second position detector may include a plurality of coils and a controller electrically connected to the plurality of coils. The controller may receive inductance values from the plurality of coils and detect the position of the lens barrel 210 in the first axis (x-axis) direction and the second axis (y-axis) direction.

The plurality of coils may also be copper foil patterns laminated and embedded in the substrate 600, similar to the first OIS driving coil. The plurality of coils may be arranged on either side of the first OIS driving coil or the second OIS driving coil. For example, in a case where the plurality of coils includes two coils, one coil may be placed on either side of the first OIS driving coil or the second OIS driving coil.

Hereinafter, for convenience of explanation, it is described that a plurality of coils are arranged on both sides of the first OIS driving coil, but it is not limited thereto, and a plurality of coils may be disposed on both sides of the second OIS driving coil, or it may not include a plurality of coils.

The first OIS driving magnet 510a may be disposed to face the first OIS driving coil in the first axis (x-axis) direction. In addition, one side of the first OIS driving magnet 510a may be disposed to face a portion of one of the plurality of coils of the second position detector, and the other side of the first OIS driving magnet 510a may be disposed to face a portion of another one of the plurality of coils of the second position detector. Here, the coil partially facing one side of the first OIS driving magnet 510a may be a first-first sensing coil, and the coil partially facing the other side of the first OIS driving magnet 510a may be a first-second sensing coil.

As the first OIS driving magnet 510a moves in the first axis (x-axis) direction and/or the second axis (y-axis) direction, the inductance of a plurality of coils of the second position detector may change. Therefore, the position of the first OIS driving magnet 510a may be detected from the change in the inductance of a plurality of coils. The first OIS driving magnet 510a is mounted on the lens holder 320, the lens barrel 210 is mounted on the lens holder 320, and the lens holder 320 may move together with the lens barrel 210 in the first axis (x-axis) direction and/or the second axis (y-axis) direction. Therefore, the position of the lens barrel 210 (position in the first axis (x-axis) and/or second axis (y-axis) direction) may be detected from the change in inductance of the plurality of coils of the second position detector.

The second rolling member B2 may be accommodated in the first guide recess 301 and disposed between the carrier 300 and the frame 310. The third rolling member B3 may be accommodated in the second guide recess 311 and disposed between the frame 310 and the lens holder 320. The fourth rolling member B4 may be accommodated in the accommodation recess 302 and disposed between the carrier 300 and the lens holder 320.

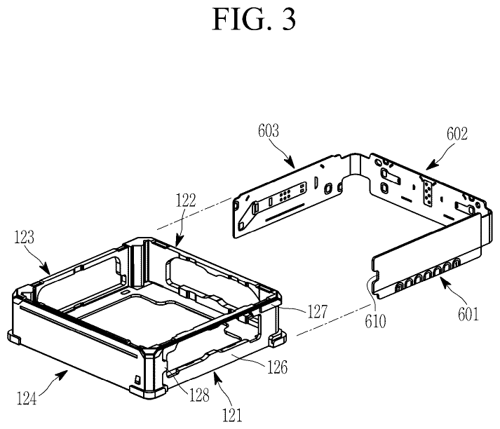

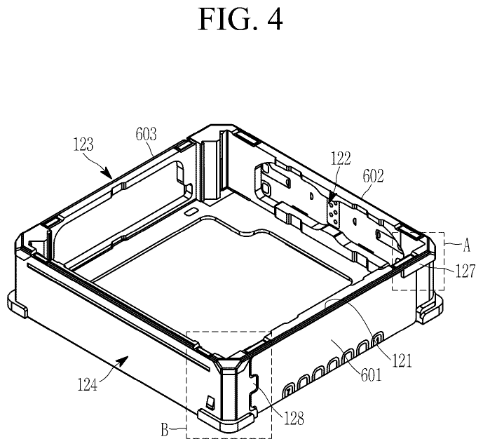

FIG. 3 is an exploded perspective view of the housing 120 and the substrate 600 of FIG. 2, and FIG. 4 shows the substrate 600 fixed to the outer surface of housing 120.

Referring FIG. 3 and FIG. 4, the substrate 600 may be disposed on the outer surfaces of side walls 121, 122, 123, 124 of the housing 120. For example, the substrate 600 may be disposed to surround the outer surfaces of the side walls 121, 122, 123, 124 of the housing 120 so as to be in contact with at least a portion of the outer surfaces of the side walls 121, 122, 123, 124 of the housing 120.

A fastening recess 126 may be formed in at least a portion of the outer surfaces of the side walls 121, 122, 123, 124 of the housing 120. The fastening recess 126 has a groove structure that extends toward the inner center region of housing 120. That is, the fastening recess 126 has a groove structure that extends toward the inner center region of the housing 120 in a direction orthogonal to the vertical direction more than the adjoining region. Accordingly, a step may be formed between the fastening recess 126 and the region outside the fastening recess 126 on the outer surfaces of the side walls 121, 122, 123, 124 of the housing 120.

The substrate 600 may be disposed in the fastening recess 126 and disposed on the outer surfaces of the side walls 121, 122, 123, 124 of the housing 120. As an example, a depth of the fastening recess 126 may be provided to correspond to a thickness of substrate 600.

The side walls of the housing 120 may include a plurality of side walls 121, 122, 123, 124 that meet each other with vertical corners interposed between them.

The fastening recess 126 may be formed across at least two side walls of the side walls 121, 122, 123, 124 of the housing 120. In addition, the fastening recess 126 formed in each side wall 121, 122, 123, 124 may be connected to each other.

The substrate 600 may have a predetermined length along the circumference direction of the housing 120. The circumferential length of the substrate 600 may be provided to be longer than the circumferential length of at least one of the side walls 121, 122, 123, 124 of the housing 120. Accordingly, the substrate 600 may be disposed to surround at least two outer surfaces of the side walls 121, 122, 123, 124 of the housing 120. The substrate 600 can have a predetermined width in the vertical direction. The width of substrate 600 may vary from region to region along the length direction of substrate 600. For example, the substrate 600 may have a smaller vertical width in a region positioned at a corner of the housing 120 than in other regions.

The side walls of the housing 120 may include a first side wall portion 121, a second side wall portion 122, a third side wall portion 123, and a fourth side wall portion 124. The first side wall portion 121 may be disposed to face the third side wall portion 123 with an inner center region of the housing 120 interposed therebetween. The second side wall portion 122 may be disposed to face the fourth side wall portion 124 with the inner center region of the housing 120 interposed therebetween. The second side wall portion 122 and the fourth side wall portion 124 may be disposed at each end of the first side wall portion 121. The first side wall portion 121 and the third side wall portion 123 may be disposed at each end of the second side wall portion 122. The second side wall portion 122 and the fourth side wall portion 124 may be disposed at each end of the third side wall portion 123. The third side wall portion 123 and the first side wall portion 121 may be disposed at each end of the fourth side wall part 124.

The fastening recess 126 may be formed across the first side wall portion 121, the second side wall portion 122, and the third side wall portion 123. The fastening recess 126 formed in the first side wall portion 121, the second side wall portion 122, and the third side wall portion 123 may be connected to each other. A shape of the fastening recess 126 may be provided to correspond to a shape of the substrate 600. For example, the substrate 600 may include a first region 601, a second region 602, and a third region 603. The first region 601, the second region 602, and the third region 603 may be disposed along the circumference direction of the side walls 121, 122, 123, 124 of the housing 120.

The first region 601 and the third region 603 may be disposed at both ends of the substrate 600 along the circumference direction of the side walls 121, 122, 123, 124 of the housing 120, and the second region 602 may be disposed between the first region 601 and the third region 603. The substrate 600 may be disposed across the first side wall portion 121, the second side wall portion 122, and the third side wall portion 123 of the housing 120.

The first region 601 may be bent relative to the second region 602, the third region 603 may be bent relative to the second region 602, the first region 601 may be disposed on the first side wall portion 121, the second region 602 may be positioned on the second side wall portion 122, and the third region 603 may be positioned on the third side wall portion 123.

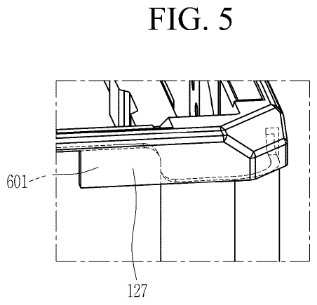

FIG. 5 shows an A region of FIG. 4.

Referring to FIG. 5, a fastening cover portion 127 may be disposed on the side walls 121, 122, 123, 124 of the housing 120. The fastening cover portion 127 may be provided to cover at least a portion of the outer surface of the substrate 600 disposed on the outer surface of the side walls 121, 122, 123, 124 of the housing 120. For example, the fastening cover portion 127 may be provided to cover at least some region of the fastening recess 126. At this time, the fastening cover portion 127 may be spaced apart from the fastening recess 126 in a direction orthogonal to the vertical direction, and may be disposed to cover at least a portion of the fastening recess 126. A distance between the outer surface of the fastening recess 126 and the fastening cover portion 127 may correspond to a thickness of the substrate 600. Accordingly, when the substrate 600 is disposed on the outer surface of the side walls 121, 122, 123, 124 of the housing 120, at least some region of the substrate 600 is disposed between the outer surface of the side walls 121, 122, 123, 124 of the housing 120 and the fastening cover portion 127 and is covered by the fastening cover portion 127.

The fastening cover portion 127 may be disposed at an upper portion of the outer surface of the side walls 121, 122, 123, 124 of the housing 120. For example, the fastening cover portion 127 may have a predetermined length and extend downward from the upper portion of the side walls 121, 122, 123, 124 of the housing 120.

The fastening cover portion 127 may be disposed to cover at least a portion of the first region 601 of the substrate 600. That is, the fastening cover portion 127 may be disposed on the first side wall portion 121 of the housing 120 and may cover at least a portion of the first region 601 of the substrate 600 disposed on the first side wall portion 121. In addition, the fastening cover portion 127 may be disposed on the third side wall portion 123 of the housing 120 and may cover at least a portion of the third region 603 of the substrate 600 disposed on the third side wall portion 123.

The fastening cover portion 127 may be disposed adjacent to a region where the substrate 600 is bent. For example, when the fastening cover portion 127 is disposed on the first side wall part 121, the fastening cover portion 127 may be disposed adjacent to a corner where the first side wall portion 121 and the second side wall portion 122 meet each other. In addition, when the fastening cover portion 127 is disposed on the third side wall portion 123, the fastening cover portion 127 may be disposed adjacent to a corner where the third side wall portion 123 and the second side wall portion 122 meet each other.

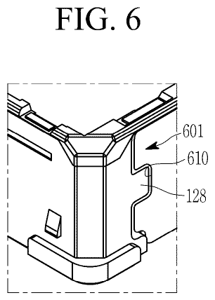

FIG. 6 shows a region B of FIG. 4.

Referring to FIG. 6, a hanging recess 610 may be formed at a length direction end of the substrate 600. The hanging recess 610 may be formed to be concave toward an opposite direction of the corner of the housing 120. For example, when the hanging recess 610 may be formed at an end of the first region 601 of the substrate 600, the hanging recess 610 may be formed to be concave toward the second region 602 of the substrate 600. In addition, when the hanging recess 610 may be formed at an end of the third region 603 of the substrate 600, the hanging recess 610 may be formed to be concave toward the second region 602 of the substrate 600. FIG. 3 illustrates an example where the hanging recess 610 is formed in the first region 601 of the substrate 600.

A support portion 128 inserted into the hanging recess 610 of the substrate 600 may be disposed on the outer surface of the side walls 121, 122, 123, 124 of the housing 120. For example, when the fastening recess 126 has a shape corresponding to the substrate 600, the support portion 128 may be formed in a direction in which the fastening recess 126 and the boundary outside the fastening recess 126 intersect with respect to the vertical direction. When the substrate 600 may be disposed on the outer surface of the side walls 121, 122, 123, 124 of the housing 120, the hanging recess 610 of the substrate 600 is disposed at the support portion 128. The support portion 128 may support the length direction end of the substrate 600 to prevent the substrate 600 from sagging downward.

The camera module 1000 according to the embodiment may prevent a substrate 600 from being damaged by a cover 110 during an assembly process. Specifically, when the substrate 600 is positioned on the outer surface of the side walls 121, 122, 123, 124 of the housing 120, the substrate 600 is bent. At this time, an inner surface of the substrate 600 may not be in close contact with the outer surface of the housing 120 and may be lifted. In this state, if the cover 110 is placed on the outside of the housing 120 and the substrate 600, the substrate 600 may be damaged by the cover 110. The camera module 1000 according to the embodiment is provided such that the fastening cover portion 127 covers at least a portion of the outer surface of the substrate 600. Accordingly, when positioning the substrate 600 on the outer surface of the side walls 121, 122, 123, 124 of the housing 120, the inner surface of the substrate 600 may be prevented from being lifted relative to the outer surface of the housing 120. In addition, in the process of covering the cover 110 on the outside of the housing 120 and the substrate 600, the fastening cover portion 127 may prevent contact between the substrate 600 and the cover 110.

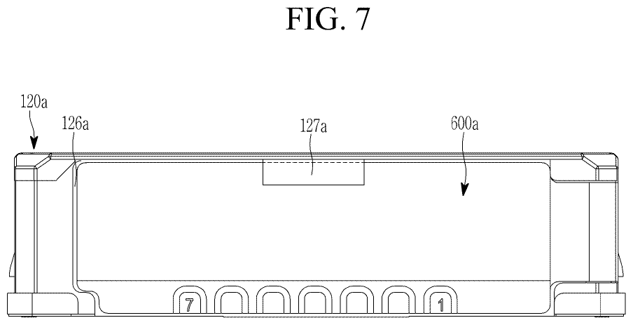

FIG. 7 shows a housing 120a and a substrate 600a according to another embodiment.

Referring to FIG. 7, a fastening cover portion 127a may be disposed on a side wall of housing 120a. The fastening cover portion 127a is provided to cover at least a portion of an outer surface of the substrate 600a disposed an outer surface of the side wall of the housing 120a. As an example, the fastening cover portion 127a may be provided to cover at least some region of the fastening recess 126a. At this time, the fastening cover portion 127a may be disposed apart from the fastening recess 126a in a direction orthogonal to the vertical direction. A distance between the outer surface of fastening recess 126a and fastening cover portion 127a may correspond to a thickness of the substrate 600a. Accordingly, when the substrate 600a is disposed on the outer surface of the side wall of the housing 120a, at least some region of the substrate 600a is disposed between the outer surface of the side wall of the housing 120a and the fastening cover portion 127a and is covered by the fastening cover portion 127a.

The fastening cover portion 127a may be disposed at an upper portion of the outer surface of the side wall of the housing 120a. For example, the fastening cover portion 127a may have a predetermined length and extend downward from the upper portion of the side wall of the housing 120a. The fastening cover portion 127a may be disposed in a central or intermediate region between the corners of the housing 120a.

The fastening cover portion 127a, identically or similarly to that described above in FIG. 5, may be disposed to cover at least a portion of the first region of the substrate 600a, and a repeated description thereof is omitted. In addition, the fastening cover portion 127a, identically or similarly to that described above in FIG. 5, may be disposed to cover at least a portion of the third region of the substrate 600a, and a repeated description thereof is omitted. In addition, a hanging recess may be formed in the substrate 600a and a support portion may be formed in the housing 120a, identically or similarly to that described above in FIG. 6, and a repeated description thereof will be omitted.

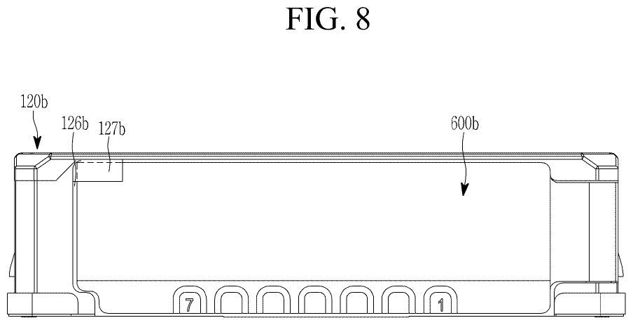

FIG. 8 shows a housing 120b and a substrate 600b according to another embodiment.

Referring to FIG. 8, a fastening cover portion 127b may be disposed on a side wall of the housing 120b. The fastening cover portion 127b is provided to cover at least a portion of an outer surface of the substrate 600b disposed an outer surface of the side wall of the housing 120b. As an example, the fastening cover portion 127b may be provided to cover at least some region of the fastening recess 126b. At this time, the fastening cover portion 127b may be disposed apart from the fastening recess 126b in a direction orthogonal to the vertical direction. A distance between the outer surface of fastening recess 126b and fastening cover portion 127b may correspond to a thickness of the substrate 600b. Accordingly, when the substrate 600b is disposed on the outer surface of the side wall of the housing 120b, at least some region of the substrate 600b is disposed between the outer surface of the side wall of the housing 120b and the fastening cover portion 127b and is covered by the fastening cover portion 127b.

The fastening cover portion 127b may be disposed at an upper portion of the outer surface of the side wall of the housing 120b

For example, the fastening cover portion 127b may have a predetermined length and extend downward from the upper portion of the side wall of the housing 120b.

The fastening cover portion 127b may be disposed to cover a length direction end portion of the substrate 600b.

The fastening cover portion 127b, identically or similarly to that described above in FIG. 5, may be disposed to cover at least a portion of the first region of the substrate 600b, and a repeated description thereof is omitted. In addition, the fastening cover portion 127b, identically or similarly to that described above in FIG. 5, may be disposed to cover at least a portion of the third region of the substrate 600b, and a repeated description thereof is omitted. In addition, a hanging recess may be formed in the substrate 600b and a support portion may be formed in the housing 120b, identically or similarly to that described above in FIG. 6, and a repeated description thereof will be omitted.

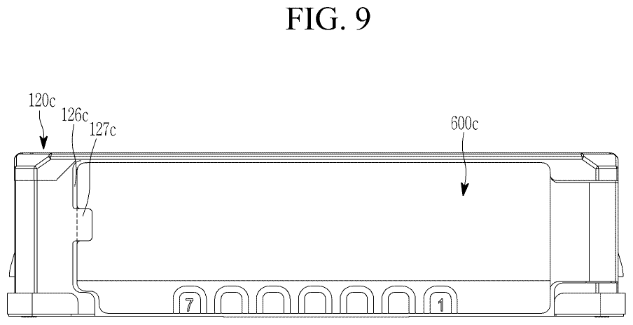

FIG. 9 shows a housing 120c and a substrate 600c according to another embodiment.

Referring to FIG. 9, a fastening cover portion 127c may be disposed on a side wall of the housing 120c. The fastening cover portion 127c is provided to cover at least a portion of an outer surface of the substrate 600c disposed an outer surface of the side wall of the housing 120c. As an example, the fastening cover portion 127c may be provided to cover at least some region of the fastening recess 126c. At this time, the fastening cover portion 127c may be disposed apart from the fastening recess 126c in a direction orthogonal to the vertical direction. A distance between the outer surface of the fastening recess 126c and the fastening cover portion 127c may correspond to a thickness of the substrate 600c. Accordingly, when the substrate 600c is disposed on the outer surface of the side wall of the housing 120c, at least some region of the substrate 600c is disposed between the outer surface of the side wall of the housing 120c and the fastening cover portion 127c and is covered by the fastening cover portion 127c.

The fastening cover portion 127c may be disposed to cover a length direction end portion of the substrate 600c. The fastening cover portion 127c may be disposed in a middle region of the outer surface of the side wall of the housing 120c in the vertical direction.

The fastening cover portion 127c, identically or similarly to that described above in FIG. 5, may be disposed to cover at least a portion of the first region of the substrate 600c, and a repeated description thereof is omitted. In addition, the fastening cover portion 127c, identically or similarly to that described above in FIG. 5, may be disposed to cover at least a portion of the third region of the substrate 600c, and a repeated description thereof is omitted. In addition, a hanging recess may be formed in the substrate 600c and a support portion may be formed in the housing 120c, identically or similarly to that described above in FIG. 6. That is, the support portion may be formed at a different height in the vertical direction from the fastening cover portion 127c, or the fastening cover portion 127c may be disposed in a region where one end in the length direction of the substrate 600c is positioned and the support portion may be disposed in a region where the other end in the length direction of the substrate 600c is positioned. Repeated descriptions of the hanging recess and the support portion are omitted.

In addition, at least two of the embodiments described in FIG. 5 to FIG. 9 may be used together. That is, a plurality of fastening cover portions may be disposed in different positions in the housing. One or more embodiments disclose a camera module in which damage to a substrate is prevented during an assembly process.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens barrel;
a carrier configured to accommodate the lens barrel;
a housing configured to accommodate the carrier;
a substrate disposed on an outer surface of a side wall of the housing;
an image sensor configured to convert incident light to an electric signal;
a circuit board electrically connected to the image sensor; and
a cover disposed to enclose the housing and the substrate,
wherein a fastening recess is disposed on the outer surface of the side wall of the housing, where the substrate is disposed, and the housing has a fastening cover portion configured to cover at least a portion of the fastening recess.

2. The camera module of claim 1, wherein
the fastening cover portion is disposed at an upper portion of the outer surface of the side wall of the housing.

3. The camera module of claim 1, wherein
the housing comprises a first side wall portion, a second side wall portion, a third side wall portion, and a fourth side wall portion, the first wall portion faces the third side wall portion, and the second wall portion faces the fourth side wall portion, and
the substrate is disposed across the first side wall portion, the second side wall portion, and the third side wall portion.

4. The camera module of claim 3, wherein
the fastening cover portion is disposed on the first side wall portion.

5. The camera module of claim 4, wherein
the fastening cover portion is disposed adjacent to a corner where the first side wall portion and the second side wall portion meet each other.

6. The camera module of claim 4, wherein
the fastening cover portion is disposed in an intermediate region between corners of the housing.

7. The camera module of claim 4, wherein
the fastening cover portion is disposed to cover a length direction end portion of the substrate.

8. The camera module of claim 7, wherein
the fastening cover portion is disposed in a middle region of the side wall of the housing in a vertical direction.

9. The camera module comprising:
a lens barrel;
a carrier configured to accommodate the lens barrel;
a housing configured to accommodate the carrier;
a substrate disposed on an outer surface of a side wall of the housing;
an image sensor configured to convert incident light to an electric signal;
a circuit board electrically connected to the image sensor; and
a cover disposed to enclose the housing and the substrate,
wherein the housing has a fastening cover portion configured to cover at least a portion of the substrate.

10. The camera module of claim 9, wherein
a fastening recess is disposed on the outer surface of the side wall of the housing.

11. The camera module of claim 10, wherein
the fastening cover portion is spaced apart from the fastening recess.
